(19) United States
(12) Patent Application Publication
(10) Pub. No.: US 2011/0058991 A1
(43) Pub. Date: Mar. 10, 2011

(54) GASIFICATION DEVICE WITH SLAG REMOVAL FACILITY

(75) Inventors: Eberhard Kuske, Soest (DE); Christoph Hanrott, Muenster (DE)

(73) Assignee: UHDE GMBH, Dortmund (DE)

(21) Appl. No.: 12/735,963

(22) PCT Filed: Feb. 13, 2009
(86) PCT No.: PCT/EP2009/001004

§ 371 Date: Nov. 5, 2010

(30) Foreign Application Priority Data
Mar. 5, 2008 (DE) 10 2008 012 732.9

(51) Int. Cl. B01J 8/00

(52) U.S. Cl. 422/187

(57) ABSTRACT

A device for the gasification of liquid or fine-grain solid fuel materials in an entrained bed reactor, at temperatures above the ash melting point and at a pressure of 0.3 to 8 MPa, including a gasification reactor and a water bath being arranged in a pressure vessel. The water bath being installed below the gasification reactor and the a/m gasification reactor being designed in such a manner that the synthesis gas produced is withdrawn in the upper section of the reactor, the liquid slag precipitating on the walls of the reactor chamber and then having a free downflow, without any solidification of the surface of the said slag. The lower side of the reaction chamber has an outlet opening with a drop-off edge so that the downstream of liquid slag can freely fall from the drop-off edge. A slag removal duct is arranged below the opening and reaches down into the water bath, the upper wall section of the slag removal duct is penetrated by a cooling agent and the internal side of the duct is completely lined with a temperature-resistant insulating compound. The lower section of the slag removal duct which reaches down into the water bath is wetted by a water film on the internal side, the upper and lower sections being connected with each other in such a manner that the water film of the upper wall section does not come into contact with the wall section penetrated by a cooling agent nor with the insulating compound.

The present invention relates a process for the gasification of fine-grain through dust type or liquid fuel materials for the generation of synthesis gas, i.e. a gas the main components of which are CO and H₂, the slag being withdrawn from the gasification reactor in a molten state and becoming solidified by cooling with water.

The gasification of fine-grain fuel materials, such as dust-type materials from coal, petroleum coke, biological waste or fuel materials as well as liquid residues, such as those originating from oil, tar, refinery residues and other liquid residues, at temperatures above the ash melting point of the input fuel material, yields slag in a molten state. The said molten slag collects in the lower section of the gasification reactor and is discharged through an outlet opening. In this case it is common practice to discharge the molten slag into a water bath in which the slag is quenched and granulated, so that a glass-type material is obtained. In connection with the gasification at elevated pressure, the documents DE 23 42 079 C3 and U.S. Pat. No. 4,328,006 A reveal that the gasification reactor and the water bath arranged below the reactor are enclosed in a joint pressure vessel. In this configuration, the pressure vessel shell encloses the gap located between the slag outlet and the water bath. It is also known that the pressure vessel has neither a brick lining nor a cooling system. Hence, the a/m arrangement requires that adequate provision must be made for the outlet stream of hot slag, gases and other particles so as to prevent heating of or damage to the pressure vessel wall.

Patent U.S. 2007 0062 117 owned by Future Energy company provides for a withdrawal of the synthesis gas together with the slag via the slag outlet opening. The pressure vessel is protected against high temperatures by cooling the synthesis gas and slag with the aid of water injected below the slag outlet. In addition to the water injection, the pressure vessel shell is lined with a protective layer to prevent any erosion and corrosion.

In accordance with Texaco patent EP 0 377 930, the synthesis gas is also discharged together with the slag via the slag outlet opening. In the EP 0 377 930 process, however, the cooling of the synthesis gas is effected such that the latter is conveyed together with the slag through an immersion duct into the water bath. The said duct simultaneously serves as a protection for the pressure vessel shell. The immersion duct itself is cooled with the aid of a water film and thus solid deposits are avoided, too.

The disadvantage of processes described in U.S. 2007 0062 117 and EP 0 377 930 is that they are merely feasible in combination with gasification processes in which the synthesis gas is withdrawn together with the slag via the slag outlet opening.

In the case of gasifiers with separate outlets for synthesis gas and slag, it is essential to prevent a cooling-down of the slag outlet. Any such cooling-down may entail a premature solidification of the slag (i.e. clogging of the slag outlet) and consequently to operational disturbances or even a shutdown of the whole unit. The processes in accordance with U.S. 2007 0062 117 and EP 0 377 930 have in common that the synthesis gas leaving the gasifier together with the slag ensures a sufficiently high temperature at the slag outlet. This is not feasible in the case of gasifiers with a separate outlet for raw gas and slag because there is no forced stream flow underneath the slag outlet. Hence, the processes described above are unsuitable for gasifiers with separate outlet for synthesis gas and slag. The process-specific requirement for the design of the slag outlet, therefore, relates to a minimisation of heat losses in the ambiance in order to prevent a premature cooling/solidification of the slag. Arranging intensely cooled (“cold”) walls of enclosure in the direct vicinity of the slag outlet would consequently entail an undesired cooling of the outlet area. A further decrease in heat would occur if vapour developed during the slag granulation (solidification) and if such vapour flew upwards in the downcomer duct. This vapour can leave the downcomer duct merely via the slag outlet and thus it would provide additional cooling of the effluent slag

Gasification devices with a separate outlet for the slag and the synthesis gases are nowadays equipped with a slag removal duct, as laid down in documents U.S. Pat. No. 5,441,547, U.S. Pat. No. 5,803,937 or EP 0 318 071. The said duct connects the slag outlet with the water bath and hence, it protects the pressure vessel wall from too high a temperature. The length of the slag removal duct may be dimensioned such that the duct reaches into the water bath or the duct end is located slightly above the water level so that a pressure balance is ensured between the slag removal duct and the annular space between the pressure vessel wall and the slag outlet.

Document EP 0 318 071 shows a slag removal duct that reaches down to a line located just above the water bath level. Moreover, a ring of spraying nozzles for slag wetting is fitted to the end of the slag removal duct. The drawing attached to document EP 0 318 071 depicts a type of wall of the slag removal duct which has no cooling system.

A disadvantage of this design is that the duct walls are exposed to a high temperature, which may cause damage to the wall and consequently lead to operational disturbances. Moreover, incrustations may form in the lower section of the slag removal duct because they may come into contact with water from the ring of nozzles. Transitional zones thus form in the boundary sectors of the conical spray stream in which the walls alternately become “dry” and “wet”. Experience has shown that any such area exhibits a considerable trend to form incrustations of solids. Even if the wall is provided with an additional liner of temperature-resistant material, the slag removal duct is exposed to high temperatures because the wall sectors located above the annular space are insufficiently cooled. Apart from an increased risk of the formation of incrustations when using temperature-resistant materials, the said liner may become subject to the formation of cracks and peeling off due to coming into contact with the sprayed water. Hence, the liner particles peeled off may cause clogging of the water bath and/or of the downstream slag removal system.

The slag removal duct described in document WO 2006 053 905 is provided with membrane walls lined with a heat-resistant material. A cooling agent flows through the membrane walls so that the wall is sufficiently cooled. A cooling down of the slag outlet can be avoided by a heat-resistant liner. However, the wall section located above the nozzles is not lined in order to preclude any chipping of insulation particles. A recipient for the water bath is arranged below the slag removal duct, the upper edge of the said vessel being equipped with a ring of nozzles for wetting the slag. A gap is provided between the ring of nozzles and the end of the slag removal duct in order to ensure a pressure balance between the reactor and the annular space. The water nozzles of the said ring in fact ensure not only wetting of the slag but also cooling and wetting of the vessel wall section not covered by the water bath level. The said vessel wall section must be selected such that the water level variations cannot cause a rise of the water level up to the ring of nozzles and/or annular space.

A disadvantageous criterion of the design described in WO 2006 053 905 is that there are wall sections that alternately become dry and wet. The said sections include the slag removal duct area without liner as well as the section of the water bath wall that is not covered by the water. Experience has shown that solids incrustations can form under these conditions and ultimately cause operational disturbances. Furthermore, the injection of water into the slag removal duct bears an increased risk of excessive cooling of the slag removal opening due to water vapour. Moreover, the water injection and the non-lined membrane walls of the slag removal duct cause an additional cooling effect on the slag outlet opening, which in the case of the a/m design can be overcome only, by means of a sufficient distance between the cooler surfaces and the water injection device.

The objective of the invention, therefore, is to provide a slag removal system for the gasification of liquid or fine-grain solid fuel materials at temperatures above the ash melting point of the fuel material and at a pressure of 0.3 to 8 MPa, the said system overcoming the demerits described above.

The objective of the invention is achieved by a device with the technical criteria laid down below:
A gasification reactor and a water bath are arranged in a pressure vessel;
The water bath is arranged below the gasification reactor;
The gasification reactor is designed in such a manner that:
   the synthesis gas produced is withdrawn from the upper section of the reactor,
   liquid slag precipitates on the walls of the reaction chamber and then has a free downflow, without any solidification of the slag surface,
   the lower side of the reaction chamber has an outlet opening with a drop-off edge so that the downstream of liquid slag can freely drop off the said edge;
A slag removal duct arranged below the said opening reaches down into the water bath and has the following technical details:
   A cooling agent flows through the upper section of the wall of the slag removal duct and the internal side of the duct is completely lined with a temperature-resistant insulating compound;
   the lower section of the slag removal duct wall which reaches down into the water bath is wetted by a water film on the internal side and linked in a gas-tight manner with the upper section;
   the upper and the lower sections of the slag removal duct are connected with each other in such a manner that the water film of the upper wall section does not come into contact with the wall section penetrated by a cooling agent nor with the insulating compound.

The gasification preferably takes place at a low particle load of <50 kg/m³—not in a fluidised bed—but instead in suspension with an oxygenous gasification agent at an elevated pressure and at temperatures above the slag melting point, the slag precipitating on the walls leaving the gasifier through an opening in the bottom while the synthesis gas is withdrawn at the head of the vessel.

In the embodiments of the invention, the feedstocks used are solid fuel materials such as coke, petroleum coke, biological waste, or biological fuel materials or plastic materials crushed or ground. The diameter size (grain size) of the fuel materials should not exceed 0.5 mm. The solid feedstock is first pressurised in one or several lock hopper devices with the aid of a non-condensible gas, such as N₂ or CO₂, the pressure ranging from 2 to 10 bar above the gasifier pressure. The solids are subsequently fed pneumatically from one or several feed vessels to the gasifier, preferably in a high-density stream. The liquid fuels are oil, tar, refinery residues or liquid suspensions. Most of the liquid fuels can be pumped to the gasifier, in the case of abrasive liquids however it is necessary to provide a lock with pressurisation using compressed gas. It is also feasible to feed a mixture of solid and liquid fuel materials. Combustible or pollutant bearing gases can also be used as feedstock. High gasification temperatures ensure a thermal decomposition of the pollutants, whereby the solid reaction products are embedded in the vitrious slag and leave the gasifier in the form of simple molecules such as H₂, CO, N₂, HCl or H₂S.

Further embodiments of the invention provide for a gasification reaction in a cloud of dust or droplets. The feeding of fuel materials and gasification agents to the gasifier can be performed by at least two burners attached by means of separate fixtures to the lateral wall of the gasification reactor. Prior to entering the reactor, the stream of gasification agents can be provided with a swirl motion by means of baffle plates or a special design of the burner.

Further embodiments of the invention provide for a water injection into an annular space, the water being required for the water film, and the said space being located behind the upper part of the slag removal duct. The annular space ensures a gas-tight connection of the upper part and the lower part of the said duct. The water injected into the annular space leaves the said space via a chamfered edge and thus generates a full-coverage water film on the lower wall section of the slag removal duct. The a/m water film does not come into contact with the upper section of the duct wall so that it is possible to provide this section with a temperature-resistant insulating compound.

In this case it is envisaged that the water film be generated by means of a rotary overflow basin which is supplied with the liquid in circumferential direction tangentially. According to an advantageous embodiment of the invention, the liquid film is produced with the aid of an overflow element of the overflow basin, the vertical cross-section of the said element forming a circular segment of at least 45°, thus obtaining a constant and even area of the wall section which reaches down into the water bath. Here, “even” is understood to mean a type of curve which can be defined as mathematical type of curve. It is good practice in this case to design the said overflow element as an overflow weir. A particular advantage can be achieved if the a/m overflow weir is formed as a circular segment of at least 90° so as to obtain a constant and even area of the wall section which reaches down into the bath level.

Water drops cannot escape from a full coverage water film and the surface area of the said water film is smaller by several magnitudes than a spectre of drops created by injection nozzles so that the cooling effect mainly produced by vaporisation remains negligible. Hence, the ambiance of the slag removal duct remains free from water drops and hot, which in fact precludes a solidification of the slag directly in the area of the drop-off edge and hence, constitutes a benefit of the invention. As the gas atmosphere in the slag removal duct thus remains dry, no incrustations can form on the wall by way of water vaporisation. In combination with the reduced cooling effect obtained by a complete lining of the upper section of the slag removal duct wall, it is possible to ensure that a small overall height of the slag removal duct can be realised.

In accordance with further embodiments of the invention, the water bath located below the reactor is designed such that it has a circulating stream.

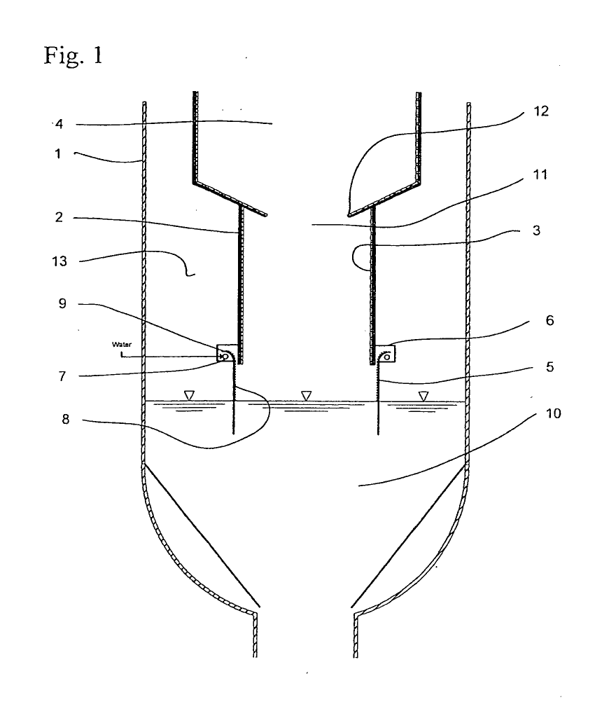

The invention is illustrated in detail on the basis of a typical configuration as shown in FIG. 1 which depicts a schematic representation of the longitudinal cross-section of a gasifier slag outlet as laid down in the present patent. It is pointed out that this design is by no means restricted to the example shown here.

The gasification of the fuel materials takes place in the reaction chamber 4, in the presence of an oxygenous gasification agent and at a pressure of 0.3-8 MPa, and above the ash melting point at temperatures of 1200-2500° C. The fuel materials, reaction agent and optionally, the wastes to be disposed of are fed by two burners fitted to the lateral side of the vessel.

The liquid slag precipitated on the walls of the reaction chamber 4 flows down the walls to the outlet opening 11, falls from the drop-off edge 12 as drops or jets into the water bath 10. The dust bearing gas obtained is withdrawn from the reaction chamber 4 via the head of the vessel.

The membrane wall 2 is arranged downstream of the reaction chamber 4 and completely lined with a temperature-resistant insulating compound 3 in order to prevent cooling down of the slag outlet opening 11. Next to the membrane wall 2 there is the annular chamber 6 connecting it to the immersion duct 5, the latter reaching down into the water bath 10. The said duct 5 is in this case designed as a simple sheet metal wall. The membrane wall 2 and the immersion duct 5 separate the pressure vessel wall 1 from the slag outlet so that an annular space 13 is formed between the pressure vessel wall and the slag outlet. In this configuration, the pressure balance between the reaction chamber 4 and the annular space 13 takes place via the water bath 10, which has a connection to the reaction chamber 4 and the annular space 13. A further pressure balance takes place via a gas quenching device not shown in the diagram and arranged above the reaction chamber 4.

In order to ensure proper cooling and to avoid formation of incrustations, a full coverage water film 8 flows over the complete surface of the section of the immersion duct 5 not covered by the water bath level. The water film 8 is generated in the annular chamber 6 which is attached to the upper edge of the immersion duct 5 and to the rear side of the membrane wall 2. The annular space 6 thus connects in a gas-tight manner the membrane wall 2 with the immersion duct 5. The water supply 7 feeds water to the annular space 6. The water is preferably supplied in circumferential direction tangentially in order to avoid sedimentation of solids. The water subsequently leaves the ring chamber 6 via an overflow weir 9, which preferably is designed as a curved drop-off edge, and it thus forms a full coverage water film 8 on the wall of the immersion duct 5. The overflow weir and the water film 8 are shaped in such a manner that the water film 8 does not come into contact with the membrane wall 2 nor with the liner 3.

### KEY TO REFERENCED ITEMS

1. Pressure vessel shell
2. Membrane wall
3. Insulating compound
4. Reaction chamber
5. Immersion duct
6. Annular space for water injection
7. Water feed line for water film
8. Water film
9. Overflow weir for water film
10. Water bath
11. Outlet opening
12. Drop-off edge
13. Annular space

1-9. (canceled)

10. A device for the removal of slag from a reactor for entrained bed gasification of liquid or fine-grain solid fuel materials at temperatures, which exceed the ash melting point of the fuel materials, and at a pressure of 0.3 to 8 MPa, with the technical criteria laid down below:
a gasification reactor and a water bath are arranged in a pressure vessel;
the water bath is arranged below the gasification reactor;
the gasification reactor is designed in such a manner that:
the synthesis gas produced is withdrawn from the upper section of the reactor;
liquid slag precipitates on the wall of the reaction chamber and then has a free downflow, without any solidification of the slag surface; and
the lower side of the reaction chamber has an outlet opening with a drop-off edge so that the downstream of liquid slag can freely drop off the said edge,
wherein
a slag removal duct arranged below the said opening reaches down into the water bath and has the following details:
a cooling agent flows through the upper section of the wall of the slag removal duct and the internal side of the duct is completely lined with a temperature-resistant insulating compound;
the lower section of the slag removal duct wall which reaches down into the water bath is wetted by a water film on the internal side and linked in a gas-tight manner with the upper section; and
the upper and the lower sections of the slag removal duct are connected with each other in such a manner that the water film of the upper wall section does not come into contact with the wall penetrated by a cooling agent nor with the insulating compound.

11. The device according to claim 10, wherein the lower wall section reaching down into the water bath has a depth of at least 0.5 m below the min. admissible water level in the said bath.

12. The device according to claim 10, wherein the wall section reaching down into the water bath has a diameter larger than that of the upper section.

13. The device according to claim 10, wherein the gas-tight connection located between the upper section and the lower section is fitted to the rear side of the upper section.

14. The device according to claim 10, wherein the liquid film wetting the internal side of the lower section is produced in the overlapping range of the upper and lower sections.

15. The device according to claim 10, wherein the liquid film is generated by means of a rotary overflow basin, which receives the liquid in circumferential direction tangentially.

16. The device according to claim 10, wherein the liquid film is produced with the aid of an overflow element fitted to the overflow basin, the vertical cross-section of the said element forming a circular segment of at least 45°, thus obtaining a constant and even area of the wall section reaching down into the water bath.

17. The device according to claim 16, wherein the overflow element is designed as an overflow weir.

18. The device according to claim 16, wherein the overflow element forms a circular segment of at least 90° so as to obtain a constant and even area of the wall section which reaches down into the water bath.
